(19) United States
(12) Patent Application Publication
(10) Pub. No.: US 2013/0249949 A1
(43) Pub. Date: Sep. 26, 2013

(54) GRAPHICAL MANIPULATION OF DIGITAL IMAGES

(71) Applicants: Itzhak Pomerantz, Kfar Saba (IL); Rahav Yairi, Oranit (IL)

(72) Inventors: Itzhak Pomerantz, Kfar Saba (IL); Rahav Yairi, Oranit (IL)

(73) Assignee: SANDISK TECHNOLOGIES INC., PLANO, TX (US)

(21) Appl. No.: 13/426,472

(22) Filed: Mar. 21, 2012

(51) Int. Cl. G09G 5/00; H04W 88/02

(52) U.S. Cl. 345/641

(57) ABSTRACT

A method for graphical manipulation of digital images includes a computing device with an interface to a memory, a processor and a graphical application that is executed on the computing device. The processor is operative, under control of the graphical application, to retrieve one or more digital images from the memory and to process each of the retrieved digital images. Processing each retrieved digital image produces a respective set of modified digital images each with a central portion and a frame portion. The central portion is produced from content of the processed retrieved digital image, and the frame portion produced with a frame style and frame attributes that are related to the content of the processed retrieved digital image.

### BACKGROUND

The classical presentation of physical pictures, paintings and photographs for people to look at includes, in most cases, a frame around the content of the physical image. The frame adds aesthetics to the displayed image and often emphasizes aspects of the content in the physical image.

Digital images displayed on mobile phones, computer screens, digital photo frames and the like are usually displayed with a similar digital frame around them. For example, most of today's high-end mobile phones, such as smartphones and the like, are able to run third-party graphical and photography applications providing high quality display of digital images. However, these applications are based on limited resources providing a rather limited user experience in the display and/or replay of digital images. Such, for example, the photography applications used today allow the user to design customized frames around the digital image, such that a digital image is displayed or replayed with the same frame in a cyclic, monotonic, loop along with a few other digital images.

Hence there is a need to provide a more creative and innovative way that will vary the display and replay of digital images and improve the user-experience when viewing such digital images on a digital screen.

### SUMMARY

Embodiments of the present invention are defined by the claims, and nothing in this section should be taken as a limitation on those claims. As a brief introduction, embodiments described in this document and illustrated in the attached drawings generally relate to a method in a computing device (e.g. a personal computer (PC) or laptop) with a processor, where the processor operates under control of a graphical application executable on the computing device to provide graphical manipulation of digital images. The processor retrieves digital images from the memory and then, while processing the digital images, produces a respective set of modified digital images for further retrieval thereof. The set of modified digital images are produced each with a central portion and a frame portion that are related to the content of the processed digital image.

Various embodiments described herein also represent a storage device with a memory and a controller and a method, in such storage device, for creating digital images for display on any host (such as a digital photo frame, a pc, a note pad, a cellular, or other mobile device and/or hard disk drive). The controller in the storage device communicates with a graphical application running on the computing device, via a host interface, for obtaining a set of modified digital images with respect to a digital image processed thereon. The set of modified digital images are then stored in the storage device memory for further retrieval thereon.

Communication between the graphical application running on the computing device and the controller in the storage device is achieved by employing any set of host operating system commands that comply with the specific communication protocol defined in the computing device. This way, the storage device can operate with various types of computing devices, including a digital photo frame, a pc, a note pad, a cellular, or other mobile and/or computing device.

These and other embodiments, features, aspects and advantages of the present invention will become better understood from the description herein, appended claims, and accompanying drawings as hereafter described.

### BRIEF DESCRIPTION OF THE DRAWINGS

The accompanying drawings, which are incorporated in and constitute a part of this specification, illustrate various aspects of the invention and together with the description serve to explain its principles. Wherever convenient, the same reference numbers will be used throughout the drawings to refer to the same or like elements.

FIG. 1 illustrates one system with a storage device in which the invention is embodied;

FIG. 2 is a flow diagram of a method of providing graphical manipulation of digital images, according to one embodiment;

FIG. 3A illustrates a system with a remote monitoring device interfacing wirelessly with a computing device, according to an example;

FIG. 3B illustrates a system with a storage device operatively coupled to a computing device, according to an example; and

FIGS. 4A, 4B, and 4C illustrate a set of modified digital images that are produced with respect to a retrieved digital image, according to one example.

### DETAILED DESCRIPTION

Various modifications to and equivalents of the embodiments described and shown are possible and various generic principles defined herein may be applied to these and other embodiments. Thus, the claimed invention is to be accorded the widest scope consistent with the principles, features and teachings disclosed herein.

The disclosed embodiments described here are based, in part, on the observation that current mobile display devices, such as mobile phones, tablets, digital photo frames, etc., provide a rather limited user experience when used for display and/or replay of digital images. This is typically so because these devices implement graphic and/or photography programs capable of providing limited graphical manipulation capabilities. Hence, in order to improve the user-experience when viewing such digital images on a digital screen there is a need to provide a way to vary the display and replay of digital images.

In general, the term “digital image” refers to any numeric (e.g. binary) representation of a two-dimensional image, whether it is a digital photograph, traditional analog photograph or illustration. The digital image may contain any number of digital values, also called picture elements or pixels, and may be of any image resolution type. Pixels are the smallest individual element in a digital image, holding quantized values that represent the brightness of a given color at any specific point in the digital image. For example, the pixels may be stored in a computer memory as a raster image (where each pixel is typically associated to a specific ‘position’ in some 2D region in the digital image) and/or a vector image (resulted from mathematical geometry). These values may be transmitted and/or stored in the memory in a compressed form or in any other format.

The digital images may be created by a variety of input host devices and techniques, such as digital cameras, scanners, coordinate-measuring machines, seismographic profiling, airborne radar, and more. They can also be synthesized from arbitrary non-image data, such as mathematical functions or three-dimensional geometric models. The term digital image may also be applied to data associated to points scattered over a three-dimensional region, such as produced by tomographic equipment.

According to an embodiment is a method of providing graphical manipulation of digital images in a computing device. The method is performed by a processor in the computing device operating under control of a graphical application that is executable on the computing device. The processor is operative to retrieve one or more digital images from the memory and to then process each of the retrieved digital images for producing a respective set of modified digital images each with a central portion and a frame portion. The processing of each retrieved digital image typically includes creating the central portion and the frame portion with respect to a modified digital image and then integrating the central portion with the frame portion to create the modified digital image. The central portion is produced from content of the processed retrieved digital image and the frame portion is produced with a frame style and frame attributes that are related to the content of the processed retrieved digital image.

Also provided is a storage device storing digital images for display on a display of any host device. The storage device may contain a controller that is configured to execute commands on the storage device. Alternatively, the storage device may be absent of a flash manager and/or other sort of controller and be directly operated by a host to which the storage device is connected to for performing host commands (e.g. read and write commands) on the storage device. In an exemplary implementation, the storage device includes a controller, a memory and a host interface for connecting with a computing device. When the storage device is operatively coupled to a computing device (such as a PC or laptop) having a graphical application executable thereon, the controller in the storage device communicates with the graphical application for obtaining a set of modified digital images with respect to a processed digital image. The controller stores the set of modified digital images in the storage device memory for further retrieval thereof. In an embodiment, the set of modified digital images are stored in the memory to allow for display of the digital images on a digital screen of a host, such as a digital photo frame, a pc, a note pad, a cellular, or other mobile device. Such storage device configuration allows for varying the display and replay of digital images on a digital display of any host system. This makes it possible to improve the overall user-experience when viewing such digital images in general.

The storage device may be a mass storage device, commonly a hard disk drive (HDD), a USB flash drive (UFD device) or a memory card with nonvolatile memory. A storage device with a nonvolatile memory retains its stored content or stored state even after power is removed. The storage device may have a configuration that complies with any memory (e.g. flash memory), Trusted Flash device, Secure Digital (“SD”), mini SD, micro SD, Hard Drive (“HD”), Memory Stick (“MS”), USB device, Disk-on-Key (“DoK”), Extreme Digital (“xD”), Multi Media Card (“MMC”), or with any other industry standard specifications. The storage device of this disclosure is also applicable with any memory card format, such as a Secured Digital (“SD”) memory card format used for storing digital media such as audio, video, or picture files. One supplier of these memory cards is SanDisk Corporation. Note that the storage device configuration does not depend on the type of removable memory, and can be built using standard two-dimensional flash memory or three-dimensional flash memory, or the like.

In general, the storage device of this disclosure may be used in any host device and designed to operate with various computing devices and computer system applications for storing digital content such as digital images. For these and other applications, the storage device's ability to obtain and store a set of modified digital images with respect to a digital image processed by a graphical application running on a computing device to which the storage device is connected is one of its attributes. Host systems that use such storage devices may be any system or device which sends and retrieves data or information to and from the storage device, including computing devices (such as personal computers (PCs), laptops and notebook computers), servers and various mobile and handset devices such as hand held computing devices, digital cameras, video cameras, cellular communication devices, audio and video reproducing devices, digital music players such as MP3 players, global positioning devices, and other electronic devices requiring removable data storage. Flash EEPROM systems are also utilized as bulk mass storage embedded in host systems. The storage device may be connected to or plugged into a compatible socket of a PDA (Personal Digital Assistant), mobile handset, and other various electronic devices.

Another possible host device is a digital photo frame (also called a digital media frame), which is a picture frame that displays digital photos without the need to print them or use a computer. The digital photo frame may display the digital images from a removable storage device or directly from a camera's memory card. Alternatively, the digital photo frame may provide internal memory storage allowing users to upload digital images to the digital photo frame's memory via a USB connection or wirelessly, using Bluetooth technology for example. For example, certain digital photo frames existing today are designed as network nodes capable of loading pictures over the Internet from various photo sharing sites.

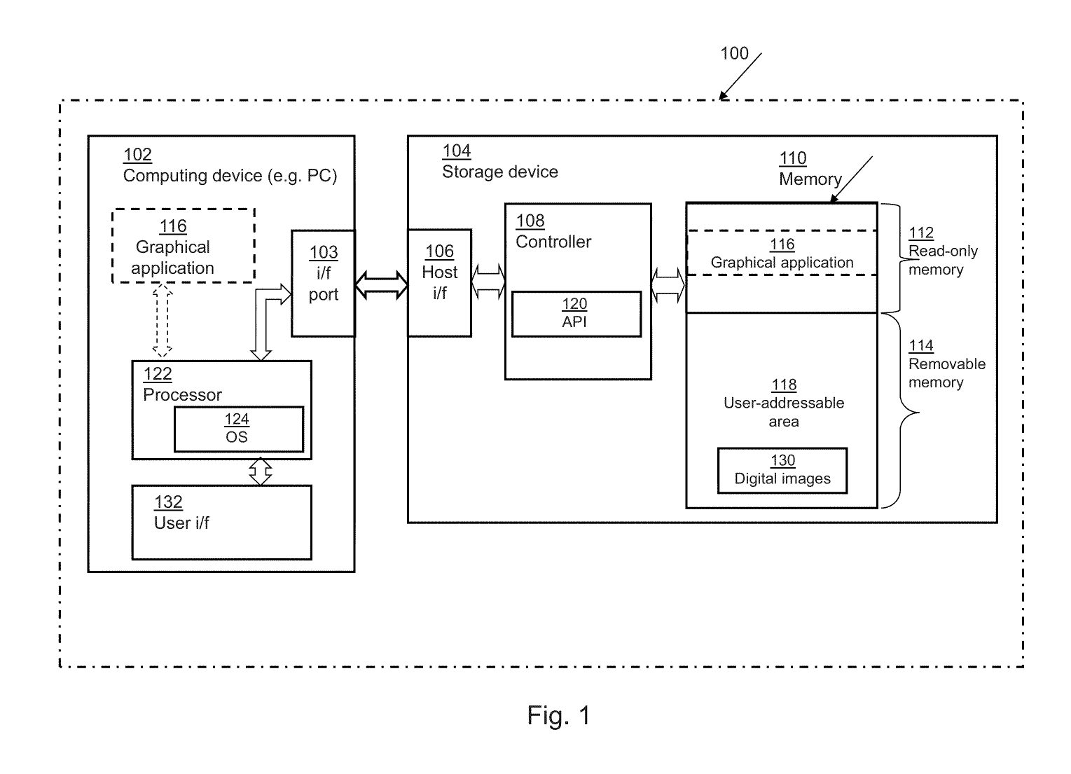

FIG. 1 illustrates one system 100 with a storage device configured according to one embodiment. System 100 includes a computing device 102 that is pluggable to a storage device 104 via an interface port 102 on the computing device 102. As shown in FIG. 1, the computing device 102 has a processor 122 and an operating system 120 running computer programs and other software applications. The computing device 102 may have more components to meet the needs of a particular application, including a user interface 132 and other user input devices (e.g. keyboard, mouse, a display monitor) for allowing interactive user operation, communications interfaces (e.g. network adapters, modems) for communicating over computer networks such as the Internet, and one or more buses for coupling its various components, among other units and application programs not shown. In one example, the operating system may conform to the Microsoft Windows™ operating system.

In a typical implementation, the storage device 104 is configured as a portable device for temporarily plugging into the computing device 102. In such case, the storage device 104 is regarded as “portable”, or as “removable”, which can be moved from one host device to another, or replaced with another. Nevertheless, the storage device 104 may be optionally regarded as “embedded”, meaning that it cannot, and is not intended to customarily be moved by a user from a host device with which it operates. Moreover, whether designed as a removable or as an embedded device for connecting with a host, the storage device 104 may be employed by the host 102 for running boot operations, including the primarily loading of a graphical application and other program applications onto the host 102 as will be further explained below.

Per the example of FIG. 1, storage device 104 is configured with a host interface 106, a controller 108 and a memory 110 storing one or more digital images among other user data and program files and applications. Memory 110 is typically based on a non-volatile flash-based memory technology. The operational blocks within the storage device 104 may be interconnected as illustrated by the arrow-ended connections. In general, the host interface 106 may facilitate wired or wireless communication between the controller 108 and a host to which the storage device 104 is connected to. The host interface 106 may include one or more ports, each port optionally conforming to one or more configuration types, such as the Secure Digital (“SD”) port specification, Advanced Security Secure Digital (“ASSD”) port specification, embedded Multi-Media Content (“eMMC”) port specification, or others.

The controller 108 in the storage device 104 is configured to interact with the memory 110 and to manage data storage and data transfer in and out of the memory 110 directly. The controller 108 is also configured to handle storage commands, such as read, write and erase commands, coming in from a host device and to perform other operations, including application invocation, control functions for power management, control functions for power management, storage device status, and configuration queries and other mass storage operations that require access to the memory 110.

As described above, when the storage device 104 is operatively coupled to the computing device 102, via the host interface 106, the controller 108 in the storage device 104 communicates with a graphical application 116 running on the computing device 102 for obtaining a set of modified digital images with respect to a digital image processed by the graphical application 116. Each of the modified digital images in the set is then stored in the memory 110, that is in the user addressable area 118 on the removable memory 114. The modified digital images are stored in the memory 110 for further retrieval thereof via the user interface 106. In an embodiment, the controller 108 stores the modified digital images in the memory 110 for allowing display and replay of the modified digital images on a digital screen of any host device, including for example a personal computer (PC), notepad, mobile phone, digital photo frame, and others. That is, rather of having the same digital image displayed over and over again on a host, each of the set of the modified digital image may be displayed instead.

The controller 108 in the storage device may operate to allow the display of a particular digital image with a respective set of modified digital images in various ways as known or yet to be known in the art, with respect to the specific image display applications of the host. Such, for example, the modified digital images may be prepared in the memory 110 by the storage device controller 108 for display on a host in a sequential manner, in random order, and/or in any other way. Functions associated with the controller 108 may be implemented in software, firmware or hardware, either in a single unit or as separate functional blocks, as shown in FIG. 1.

The graphical application 116 provided herein is a computer program employing computer readable program code that, when running on the computing device 102, utilize graphical manipulation techniques that are capable of changing the picture elements, or the pixels of a digital image in many ways. Non-limited graphical manipulation techniques include color manipulation, edge enhancement, alpha compositing and color and channel-based detection, which are utilized for applying a selective modification of a digital photo without affecting the entire picture. Other possible features include image size alternation, image cropping, noise reduction, selective color change, removal of unwanted elements (also called “inpainting”), image orientation, among other image enhancement and image editing or transformation features. The graphical application 116 employs these and other graphical manipulation techniques for producing, or creating a set of one or more modified versions of a digital image that is processed in the computing device 102.

The graphical application 116 is programmed in a way that utilizes the content (i.e. the picture elements, or pixels) of a digital image as input to the algorithms implementing it for producing a respective set of modified digital images. Each of the digital images in the set has a central portion and a frame portion, such that the central portion is produced from content of the digital image and the frame portion is produced with a frame style and frame attributes that are related to the content of the digital image.

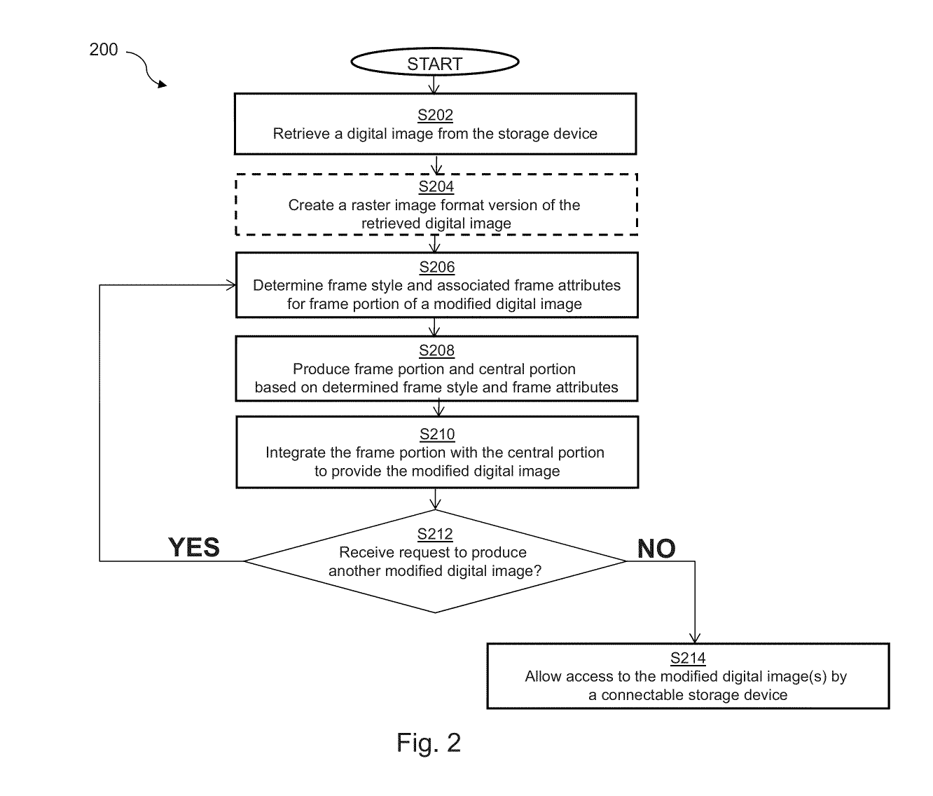

The graphical application 116 processes a digital image and while doing so carries out a variety of assessment mechanisms, as defined in the algorithm embodied in the graphical application 116. In a non-limiting implementation, the processing typically involves determining a frame style and frame attributes with respect to a new created modified digital image, then creating the frame portion and central portion based on the determined frame style and frame attributes, and then integrating the frame portion with the central portion to provide the modified digital image. Such exemplary processing scheme will be described in more detail below, with respect to FIG. 2.

The frame style and frame attributes generally include graphical manipulation techniques and other such editing effects that affect that way the frame portion and the central portion are produced with respect to a modified digital image. This means that a different frame portion is produced, or created by the graphical application 116 for each modified digital image in the set. This also means that different sets of modified digital images are created by the graphical application 116 with respect to different digital images processed in the computing device 102.

In an embodiment, the frame style may be determined based on a set of criteria that include identification of a horizon line within the digital image, identification of a (e.g. dominant, selected) shape or feature and/or dominant color in the digital image, and/or may further encompass (e.g. pixel by pixel) color manipulation of the digital image, and/or other sort of (e.g. uniform, non-uniform) modulation that may be applied to an area within the digital image. The frame attributes may be determined based on parameters that include location and shape (e.g. rectangular, oval, etc.) of the frame portion in the modified digital image, transparency extent (e.g. semi-transparent, opaque, etc.) of the frame portion within the modified digital image and/or transitional effect (e.g. straight line, fading effect) defining the graphical effect for distinguishing between the frame portion and central portion in a modified digital image.

The frame attributes may be also optionally determined based on parameters that are associated with the selected frame style of the modified digital image. For example, the frame style may encompass an identified feature (e.g. water) embedded within the frame portion of the modified digital frame, the frame attributes may be based on parameters that include location and shape of the frame portion within the modified digital image, transparency extent, transitional effect, the selected feature(s) within the digital image processed by the graphical application 116, and/or number of such selected features. Moreover, the frame attributes may determine the relation between the identified feature (e.g. water) in the digital image being processed by the graphical application 116 and between the embedded feature in the digital image (e.g. fish, desert) that is being created.

As shown in FIG. 1, the graphical application 116 may reside in the computing device 102 and executed directly from the computing device 102, or may be an executable file that is loaded onto the computing device 102 by using a suitable communications interface. In one embodiment, the graphical application 116 is configured as an executable file that resides on the storage device 104 and loaded onto the computing device 102 from the storage device 104, via the host interface 106, for running by the operating system 120 of the computing device 102. This may be achieved in a memory constellation, where the memory 110 is presented or emulated to the computing device 102 as having several storage device partitions or several logical drives.

In general, storage device partitioning is the act of dividing a memory of a storage device, such as a removable storage device, into multiple logical storage units that are referred to as “partitions”. Partitioning of the memory into multiple logical storage units is typically performed, so that the physical memory is presented or emulated to a host device with which the storage device is connected to as if it were multiple storage areas. In an example, the memory 110 may be presented to the computing device 102 as having two different partitions, such as in the form of a removable memory 114 and a read-only memory 112. The removable memory 114, typically regarded as a portion of the memory 110 that is presented to the computing device 102 as a removable memory, contains a user-addressable area 118 provided for holding user data, say, in form of user files and applications, including digital images 130, music, video, computer programs, files and other computer-readable data. This means that when plugged into the computing device 102, the removable memory 114 will appear and function to the operating system 120 of the computing device 102 as a separate logical drive (e.g. “USB flash storage drive”) that is separate from the removable memory 114. Accordingly, from the host's point of view, digital images 130, among other user files, user data and user applications reside in the user-addressable area 118 on the removable memory 114, while program files and applications reside in the read-only memory 112.

The read-only memory 112, on the other hand, is presented or emulated to the computing device 102 as a read-only storage area that prevents users from altering its stored data. The read-only memory 112 provides for a read-only storage area storing critical software components, and also advantageously an initial boot area for holding the graphical application 116, among other program files and applications, for primarily loading on a computing device.

More specifically, the read-only memory 112 may be configured to support an uploading feature allowing loading the graphical application 116 from the storage device 104 for execution on the computing device 102. One possible platform providing a suitable implementation for loading of applications and other program code being stored in a read-only partition is the TCG™ (trusted computing group) storage architecture, which is generally a security-based architecture. In the TCG™ storage architecture, this region in the memory that is presented to a computing device as a read-only partition is referred to as a “shadow-MBR” (shorthand for “shadow-Master Boot Record”). The “shadow-MBR” memory space contains data that would otherwise be available at the bottom of the LBA (logical block address) space, e.g. LBA=0 to LBA=128, and now configured to hold initial boot image (such as for operating various encryption-related devices) for primarily loading onto a computing device.

With the graphical application 116 residing in the read-only memory 112 of the storage device 104, the graphical application 116 may be configured as an executable file to run on the computing device 102 without the need to install or copy components of the graphical application 116 into local storage components on the computing device 102. The graphical application 116 may configured as such, for example, during the manufacturing of the storage device 104. Such configuration increases the portability of the storage device 104 and its use with several, differently owned computing device. For similar reasons, the graphical application 116 preferably does not involve components requiring reboot of a host computer and/or modification of any sort on a computing device. Nevertheless, this is not meant to limit the scope of this disclosure, so that the graphical application 116 may be optionally copied (loaded) onto the internal memory of a computing device for actually residing on the computing device, for example on a non-volatile memory component of the computing device.

### Communication with the Graphical Application

As already mentioned above, the graphical application 116 may reside in the computing device 102 and executed directly from the computing device 102, or may be an executable file that resides in the storage device 104 and loaded onto the computing device 102 by using a suitable communications interface. Accordingly, communication between the computing device 102 and the storage device 104, and more specifically between the graphical application 116 running on the computing device 102 and the controller 108 in the storage device 104, may be initiated, for example, upon mounting of the storage device 104 into a port in the computing device 102 (in case the storage device 104 is removably connected to the computing device 102), upon initialization of the storage device 104 in the host 102 (in case the storage device 104 is embedded within the computing device 102), or alternatively in response to a host request for data.

In a non-limiting example, a user inserts the storage device 104 into the interface port 103 of the computing device 102 to begin use of the storage device 104. The insertion of the storage device 104 into the interface port 103 may prompt drivers or components of the host operating system to trigger a “mounting process” in which a communication channel between the computing device 102 and the storage device 104 is established. During the “mounting process”, the computing device 102 establishes rules for communication with the connectable storage device 104, which rules may refer, for example, to information transfer rate, coding alphabet, communication protocol, hardware features, and so on. Following this, the graphical application 116 is launched on the computing device 102. The launching process may be performed automatically, e.g. upon mounting the storage device 104 to the computing device 102, or manually, i.e. by the user. For example, with the graphical application 116 residing on the storage device 104, the operating system 120 typically runs the graphical application 116 and associated program files from the read-only memory 112, for launching the graphical application 116 on the computing device 102 (for example at boot time). After the graphical application 116 is launched on the computing device 102, the graphical application 116 communicates with the controller 108 in the storage device 104 for accessing the memory 110 and performing graphical manipulation on the digital images stored therein.

Communication between the controller 108 in the storage device 104 and the graphical application 116 on the computing device 102 is typically achieved by the graphical application 116 employing a set of commands (e.g. read and write commands) that implement an application protocol interface (API) 124 on the storage device 104. Briefly, an application protocol interface (API) is a special set of commands (rules) and specifications that a software program can follow to access and make use of the services and resources provided by another particular software program that implements the API. The API serves as an interface between different software programs and may include specifications for routines, data structures, object classes, and protocols that may be used to communicate between a consumer program and software program that implements the API.

In a non-limiting example, the API 124 implementation on the storage device 104 utilizes standard high level “OpenFile”, “read”, “write”, and other operating system commands for allowing communication between the graphical application 116 running on the computing device 102 and the controller 108 in the storage device 104. During run time of the graphical application 116 on the computing device 102, operating system commands are translated by the host drivers for accessing the storage device 104. Typically, the commands are translated in a way that complies with the specific communication protocol defined in the computing device 102 for communication with a connectable device, such as the storage device 104. For example, the commands may be translated in a way that conforms to the Small-Computer-System-Interface (SCSI) protocol, Secure Digital (SD) protocol, Universal Serial Bus (USB) protocol, Serial Advanced Technology Attachment (SATA) computer bus interface and/or any other communication protocol.

Note that the set of commands that implement the API 124 on the storage device 104 may conform to any file system implementation and/or any communication protocol that define the way the storage device 104 communicates, or interacts with the computing device 102 for supporting the above-mentioned (e.g. read and write) operations. Such API 124 is further configured for enabling access to various memory types, including internal memory, external memory, flash-based, hard disk drive (HDD), etc. Moreover, it should be noted that the API 124 implementation may be embedded within the controller 108, or designed as a stand-alone component that communicates with the controller 108 in the storage device 104. This way, the storage device 104 is applicable to operate with any computing device and/or operating system configuration.

In an embodiment, access to a storage device by the graphical application on the computing device is conditioned to a trusted host application. A possible implementation deals with configuring the graphical application 116 as an executable file in the form of a privileged resident-application, for example, that is loaded from the storage device 104 for execution on the computing device 102. The term “privileged resident-application” is used herein to refer to an application that resides on the storage device 104 and is trusted (e.g. authenticated and verified) by the storage device 104. Such implementation allows for controlling access to data in a storage device by utilizing a privileged resident-application containing program files that are stored on the storage device and have been launched from the storage device. One way for doing this is described with regard to U.S. Pat. No. 7,921,270 entitled “Methods and Systems for Controlling Access to a Storage Device”, which discloses a way for controlling access to data in a storage device by utilizing a privileged resident-application containing program files that are stored on the storage device and have been launched from the storage device. Per the configuration, the privileged resident-application includes a program file, signed by the storage device, that has a mechanism to identify its own program processes (i.e. running software applications) when running on a computing device. This is achieved by configuring the controller of the storage device to implant a random seed sequence number in the program file(s) of the resident-application, and then programming the resident application to attach a unique command sequence number to every command that the application sends to the storage device. Such configuration allows for the storage device controller to monitor commands issued by the computing device 102 in such a manner that only commands originating from resident applications (i.e. the graphical application 116 in this case) will be recognized as such. Such configuration further allows for restricting communication of the storage device 104 to a graphical application running on the computing device to digital images that are loaded from the storage device. Commands and/or digital images originating from other source of applications (i.e. that are not loaded from the storage device 104) can be rejected by the storage device controller 108.

The above-described graphical application 116, including its program code and application files may be (either regularly or dynamically) updated to meet progressing digital graphical manipulation techniques and system configurations in any of the means known or yet to be known in the art. For example, when the storage device 104 with the graphical application 116 is in a host such as a mobile phone, the graphical application 116 may be updated with application files deployed on a server by employing Firmware Over-the-Air (FOTA) technology. FOTA technology is typically used for upgrading preloaded application files and programs used on mobile phones, personal digital assistances (PDAs), and the like, allowing users to download the relevant firmware upgrade over the air (i.e. via wireless connection) directly from their mobile phone service provider. This technology also allows manufacturers and operators to “push out” firmware upgrades to ensure that mobile consumers have the latest software improvements, which helps reduce customer support costs and increase consumer satisfaction.

Termination of the graphical application 116 on the computing device 102 may be performed automatically or manually (e.g. by the user). In one example, with the storage device 104 configured as a portable device for temporarily plugging into the computing device 102, the execution of the graphical application 116 on the computing device 102 may (e.g. automatically) terminate upon removing the storage device 104 out of the computing device 102. In another example, the graphical application 116 may create a user interface, such as a system tray entry in the Microsoft Windows™operating system, to allow the user to manually perform an orderly shutdown of the graphical application 116 and its components on the computing device 102.

Returning to FIG. 1, in the computing device 102 with the processor 122, a memory containing digital images, and the graphical application 116 that is executable on the computing device 102, the processor 122 operates under control of the graphical application 116 to provide graphical manipulation of digital images stored in the memory. The memory may be an embedded memory in the computing device 102, an external memory unit that is attachable to the computing device 102, and/or the removable memory 114 in the storage device 104.

In the context of this disclosure, the processor 122 is configured to retrieve one or more digital images from the memory and to process each of the retrieved digital images in the computing device 102. The processing of each retrieved digital image produces a respective set of modified digital images each with a central portion and a frame portion, such that the central portion is produced from content of the processed digital image and the frame portion is produced with a frame style and frame attributes that are related to the processed digital image.

The way in which the processor 122 in the computing device 102 operates, under control of the graphical application 116, to process a digital image and produce a respective set of one or more altered, or modified digital images thereof may depend on the specific algorithms embodying the graphical application 116, as will be described in more details below with respect to FIG. 2. In an embodiment, the processing of each retrieved digital image involves interactive user selection, via the user interface 132, so that the set of criteria and/or a set of parameters are determined in response to and based on user input. This can be achieved, for example, by a user selecting from a menu one or more desired frame style and, optionally, also the frame attributes that are associated with the selected frame style(s). Such user selection may trigger the processor 122, under control of the graphical application 116, to produce the set of modified digital images, so that a modified digital image is produced with respect to each selected frame style.

The above-disclosed configuration allows for creating digital images for varied display on a host device. Although the examples provided herein focus on the graphical application 116 that, when running on the computing device 102, prompts the processor 122 to communicate with the storage device 104 by utilizing the API 124 implementation on the storage device 104, it is contemplated that the graphical application 116 may be generally configured, when running on a computing device, to communicate with a connectable device in any other way that is known in the art or yet to be discovered.

It should be noted that the storage device may contain a flash manager, such as in the design of a controller, which is configured to execute commands on the storage device. Alternatively, the storage device may be absent of a flash manager and/or other sort of controller and be directly operated by a computing device to which it is connected to for performing host commands (e.g. read and write commands) on the storage device. Moreover, by configuring the storage device 104 to communicate with a graphical application for allowing for storing a set of modified digital images with respect to a digital image that has been processed by the graphical application, it is possible to operate the storage device 104 with any computing device in a manner that is transparent to this computing device.

FIG. 2 is a flow diagram illustrating a method 200 for providing graphical manipulation of digital images, according to one embodiment. FIG. 2 will be described in conjunction with FIG. 1, where a graphical application employing graphical manipulation techniques is executable on a computing device. Method 200 is performed by the processor 122 in the computing device 102 operating under the graphical application 116 for performing graphical manipulation of digital images. A particular implementation of method 200 includes the processor 122 operating under control of the graphical application 116 and communicating with the controller 108 in the storage device 104. Again, communication between the graphical application 116 running on the computing device 102 and the controller 108 in the storage device 104 may be achieved by utilizing (e.g. read and write) commands that implement the API 124 on the storage device 104.

At S202, the processor 116 operates under control of the graphical application 116 to retrieve a digital image from a storage medium and process it accordingly. In a typical implementation, the digital image is retrieved from the memory of a connectable storage device; namely, from the user-addressable area 118 on the removable memory 114. If the removable memory 114 is a secure media, for example, then an authentication process providing for mutual authentication between the storage device 104 and the computing device 102 may follow. The authentication process, typically initiated by the processor 122, may involve an exchange of an authorized password between the storage device 104 and the computing device 102 for opening a secure session with the computing device 102. This means that the storage device 104 (e.g. the storage device controller 108) must authenticate itself in front of the computing device 102 before allowing the graphical application 116 on the computing device 102 access to a requested digital image(s), and optionally other data, residing on the user-addressable area 118 in the memory 110. Alternatively, the digital images may be retrieved from the computing device's internal memory or from any other source, such as via the web.

Once the digital image is retrieved from the memory, the processor 122 processes the digital image (steps S204 through S210) for producing a respective set of modified digital images. Per FIG. 2, the processing involves optionally creating, at step S204, a copy (e.g. raster image format version) of the retrieved digital image. The raster image format version is the new created modified digital image. The digital image processing yet further involves determining, at S206, a frame style and frame attributes for the frame portion of the modified digital image and then producing, at S208, the frame portion and the central portion. The central portion is produced from content of the digital image that is received at S202 and the frame portion is produced with the frame style and frame attributes that were determined at S206. In an embodiment, the digital image processing involves scaling down the digital image, so that the central portion is a scaled down version of the digital image that is retrieved at S202. In an embodiment, the digital image processing involves employing (e.g. pixel by pixel) color manipulation to the digital image, so that for example the frame portion is produced by changing the color contrast of a pre-defined area around the central portion in a digital image, thus giving the frame portion a darker look. In another embodiment, the digital image processing involves identifying one or more features, such as a horizon line, or other elements in the retrieved digital image so that the frame portion and/or central portion are produced in association with the identified one or more features. Thus, for example, the frame portion may include clipart features (e.g. fish) in a pre-defined area around an identified element (e.g. water, a boat) in the retrieved digital image.

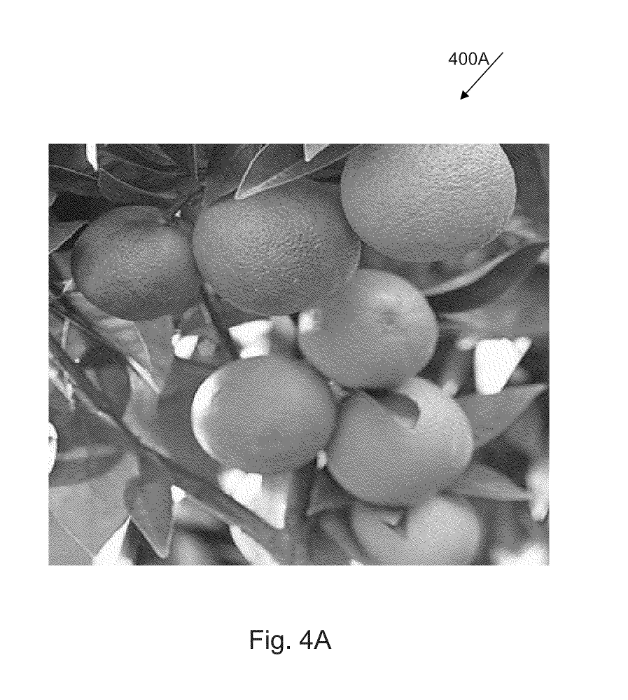

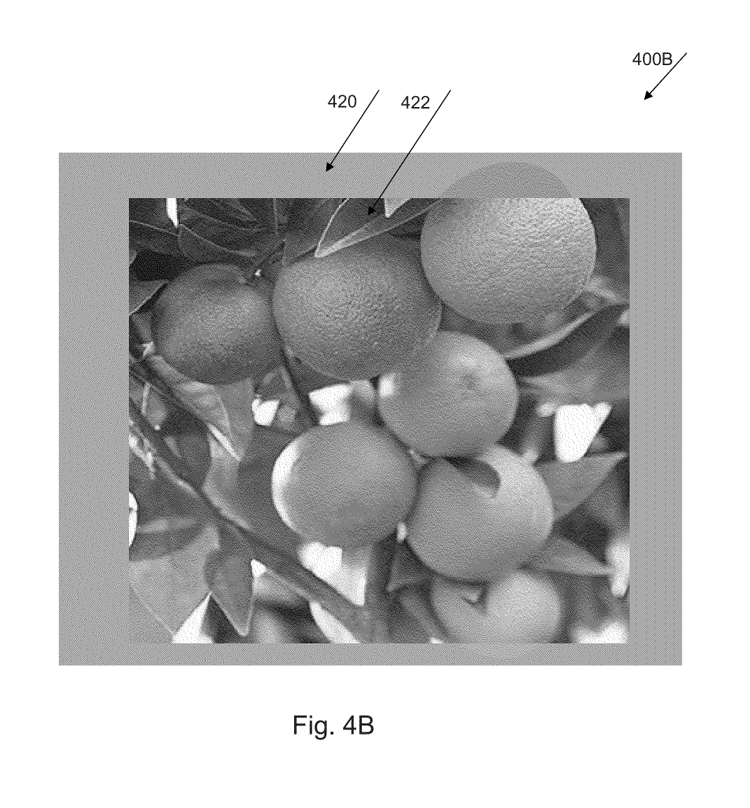

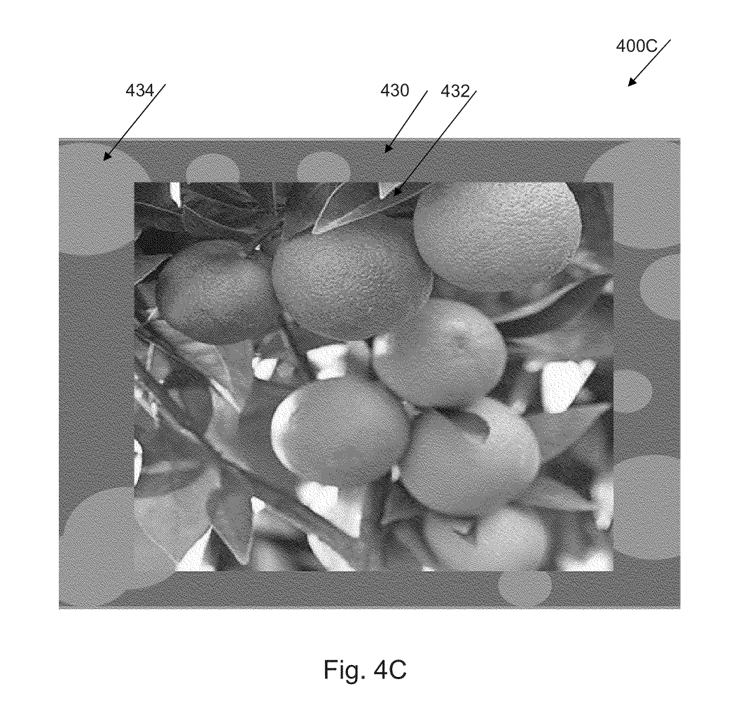

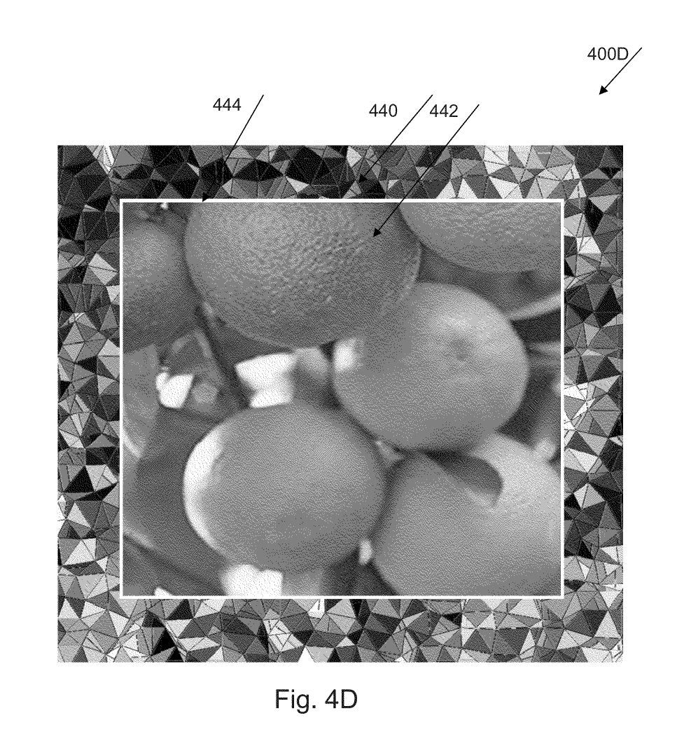

In yet another embodiment, the frame portion may be produced with a frame style that encompasses pixel by pixel graphical manipulation of a pre-defined area around the central portion of a digital image, thus giving the frame portion a visual blurring effect. Creating a blurry effect as such may be achieved by employing any well known image processing procedure, such as that created by “Gaussian blur”. Gaussian blur (also known as Gaussian smoothing) is the result of blurring a digital image by a Gaussian function. Gaussian blur is a widely used effect in graphics software, typically used to reduce image noise. The visual effect of this blurring technique is a smooth blur resembling that of viewing the digital image through a translucent screen. Non-limiting examples showing frame portions and central portions as produced with respect to a modified digital image will be described below in association with FIGS. 4A through 4D.

Further as part of the processing procedure that is performed by the processor 122 under control of the graphical application 116, the frame portion is integrated with the central portion, at step S210, to provide the modified digital image. This may be achieved by adding (e.g. copying) the frame portion and central portion into the required location in the new created (bitmap) digital image. In an embodiment, such integration process involves editing a line, a fading effect, and/or other transitional effect and adding it onto the new created bitmap image, for example around the area of the frame portion. The added effect allows for graphically distinguishing between the frame portion and the central portion in the modified digital image.

Next, at S212, the processor 122 determines whether a request for producing another modified digital image is received. Note that such request may be received via an indication coming in from the graphical application 116 and/or the computing device 102, the indication prompting the processor 122, under control of the graphical application 116, to provide yet another modified digital image with respect to the digital image that is retrieved at S202. If received (shown as “YES” at S212), the processor 122 returns to step S206. However, if such a request is not received (shown as “NO” at S212), the processor 122 proceeds to step S214 where it allows access to the modified digital image(s) by a connectable storage device. With the modified digital image produced in the bitmap format, as in the example above, this step may include converting the bitmap image and scaling it down according to a desired format for display on a host device.

It should be noted that the processing of a digital image and the producing of a modified digital image with a central portion and a frame portion as such is provided here as an example only and is not meant to limit the scope of this disclosure. Accordingly, the graphical application 116 may employ algorithms and/or graphical manipulation techniques for processing a retrieved digital image and/or that are capable of changing the picture elements, or the pixels of a digital image to modify or enhance the digital image in many other ways. It should be further noted that the command flow described herein above with respect to FIG. 2 is an example only that is not meant to limit the scope of this disclosure, so that various modifications, variations, alterations, situations, and equivalents can be apparent and any activity can be repeated and any activity can be performed by multiple entities.

Moreover, the tasks that are part of the loading of the graphical application 116 on the computing device 102, the processing of a digital image by the processor 122 under control of the graphical application 116 for producing a set of modified digital images, and other operations performed by the processor 122 and/or the graphical application 116 do not necessarily require reboot of the computing device 102 or installation of permanent files into local storage components on the computing device 102.

As can be, such command flow provides for the processor 122 in the computing device 102 to operate under control of the graphical application 116 for performing all the operations that are required for producing a set of modified digital images with respect to a digital image being stored in the memory 110.

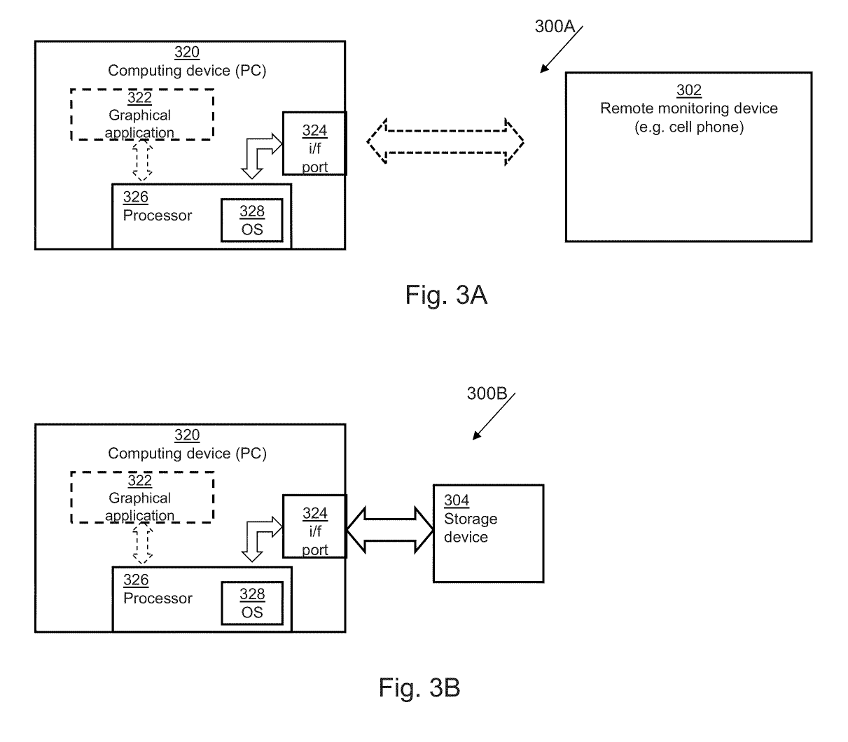

FIG. 3A illustrates a system 300A with a remote monitoring device interfacing wirelessly with a computing device for remote operation of a graphical application executable on the computing device, according to an embodiment. FIG. 3A will be described in conjunction with FIG. 1, where a graphical application 322 is executable on a computing device (e.g. PC 320) and an interface port 324, a processor 326 and an operating system 328 in the PC 320 operate in a similar manner to their respective modules of FIG. 1. A particular implementation of system 300 includes the remote monitoring device 302 operating as a high-end mobile phone, such as a smartphone and the like, and communicating with a computing device, such as personal computer (PC) 320 (or laptop), for remote monitoring of the computing device via the remote monitoring device 302. The remote monitoring device 302 may combine the functions of a mobile communication device and a computing device offering a wide variety of computing capabilities, such as Internet access and web browsing applications, wireless communications, GPS navigation, gaming and photography.

Communication between the remote monitoring device 302 and the PC 320 may be achieved by using suitable wireless communications means, such as internet communication or Wireless Fidelity (“WiFi”) or other wireless and/or cellular networking technology known or yet to be known in the art that allows computers and other devices to communicate over a wireless signal.

Per FIG. 3A, the remote monitoring device 302 interfaces wirelessly with the PC 320 for remote operation of the graphical application 322 running on the PC 320. That is, the remote monitoring device 302 operates as a remote control of the PC 320 for (off-line or real time) remote operation of the graphical application 322 running on the PC 320. The remote operation that is carried out by the remote monitoring device 302 is typically based on commands which instructions are provided by a user operating the remote motoring device 302. The commands sent out from the remote monitoring device 322 prompt operation of the processor 326, under control of the graphical application 322, for example to print, edit, delete, tag, and/or add a note with respect to a set of one or more digital images.

In a non-limiting example, a user uses his mobile phone (i.e. remote monitoring device 302) with a digital photo frame (not shown), for example, for capturing a digital image. Digital photo frame 310 is typically a picture frame that displays digital images, such as digital photos, without the need to print them or use a computer. The captured digital image can include an identification mark in the form of a Quick Response (QR) code or a respective serial number, embedded in the frame portion of the digital image, for example. A QR code is a type of matrix barcode (or two-dimensional code) consisting of black modules arranged in a square pattern on a white background. The QR code is designed to allow its content to be decoded at high speed. As such, the processor 326, operating under control of the graphical application 322 running on the PC 320, may be operative to decipher the QR code that is attached to (e.g. embedded in) the digital image and identify the received digital image accordingly.

After capturing the digital image, the user then operates his mobile phone; that is, the remote monitoring device 302, for interfacing wirelessly with the PC 320. With the remote monitoring device 302 interfacing wirelessly with the PC 320, the digital image is communicated to the PC 320 from the remote monitoring device 302 along with an instruction provided by the user. The user initiates communication with the PC 320 via the remote monitoring device 302 as such for sending out the captured digital image along with an instruction which command is stored on the PC 320. That is, the remote monitoring device 302 interfacing wirelessly with the PC 320 prompts the processor 326, under control of the graphical application 322, to store commands which instruction is received from the remote monitoring device 302. The instruction may be communicated to the PC 320 over web networking services, such as social networking services, any and other existing and/or yet to be developed platforms. Again, the instruction may be in form of a text message, and/or other marking, which command is to print, edit, delete, tag, and/or add a note with respect to a set of one or more digital images in the memory.

FIG. 3B illustrates a system 300B with a storage device operatively coupled to a computing device (such as a PC), according to an embodiment. FIG. 3B will be described in conjunction with FIG. 3A, where a storage device 304 is operatively coupled to the PC 320 via the host interface, i.e. interface port 324, and set of one or more commands coming in from the remote monitoring device 302 are stored on the PC 320 with respect to a digital image in the memory. The storage device 304 may be a dedicated non-removable storage module (SIM card for example) that is not removable from the remote monitoring device 302, or a removable storage device that is configured for removal from and addition to the remote monitoring device 302.

Per FIG. 3B, with the storage device 304 operatively coupled to the computing device via the host interface, the processor 326 in the PC 320, under control of the graphical application 322, communicates with the storage device 304 for executing the stored commands on the storage device 304. More specifically, the processor 326 in the PC 320, under control of the graphical application 322, identifies the digital image that is communicated to the computing device from the remote monitoring device 302 (for example based on the QR code that is embedded in the digital image) and executes the stored command on the storage device 304 accordingly. For example, in case the command that was sent out from the mobile phone (i.e. remote monitoring device 302) includes an instruction for editing (e.g., rotate, crop), adding a note to, and/or changing or modifying a digital image(s) in any way, this prompts the processor 326 on the computing device, under control of the graphical application 322, to communicate with the storage device 304 for executing the respective command(s) on the storage device 304 and updating the digital image(s) on the storage device 304 memory accordingly.

It should be noted that the remote operation between the computing device and the remote monitoring device 302 and/or the storage device 304, as described above, requires no change on the computing device to which the remote monitoring device and/or the storage device are connected to. Moreover, the way in which the computing device and/or associated processor operates and further interacts with the remote monitoring device 302 and/or the storage device 304 may depend on the various applications running on the computing device and, optionally, on the specific implementation logic of the graphical application running on the computing device.

FIGS. 4A, 4B, 4C and D4D illustrate a set of modified digital image produced with respect to a digital image, according to one example. FIG. 4A illustrates an exemplary digital image 400A that is processed by the processor operating under control of the graphical application. The set of modified digital images (400B, 400C and 400D) are produced each with a central portion and a frame portion based on content of the digital image 400A.

Modified digital image 400B of FIG. 4B is produced with a frame portion 420 and a central portion 422, based on content of digital image 400A. As shown in FIG. 4B, the frame portion 420 of modified digital image 400B is produced with a frame style that encompasses graphical manipulation of a pre-defined area around the central portion 414, thus distinguishing between a main feature (e.g. the oranges) and the rest of the digital image and creating a homogenous shade effect. The central portion 422 is a basically an un-modified copy of the (original) digital image 400A.

In a similar manner, FIG. 4C includes modified digital image 400C having a frame portion 430 and central portion 432. The frame portion 430 is produced in association with an identified feature (i.e. oranges) in the original digital image 400A. As shown in FIG. 4C, the frame portion 430 is produced with a frame style that includes spherical features 434 shaped like oranges that are added onto the frame portion in the modified digital image 400C. (Here too, the central portion 432 is an un-modified copy of the original digital image 400A).

FIG. 4D includes modified digital image 400D having a frame portion 440 and central portion 442, where the frame portion 440 is produced by employing graphical manipulation techniques for providing a mosaic effect around the central portion 442 in the modified digital image 400D. In digital imaging, a mosaic typically refers to the creation of a plurality of non-overlapping digital images, arranged in some tessellation. One example for this is a tile mosaic effect, which is well known digital image processing technique that involves breaking down a digital image into individual tiles arranged in a non-overlapping fashion, e.g. e.g. into colored triangular tiles formed from pixels of a pre-defined area of the original digital image. Here, the central portion 442 is a basically an un-modified copy of a pre-defined area around the original digital image 400A. A transitional effect in form of a quadrilateral line 444 is created for distinguishing between the frame portion 440 and central portion 442 in the modified digital image 400D.

In sum, the foregoing described a method for graphical manipulation of digital images for display on a host device. In a computing device with a processor, a memory and a graphical application that is executable on the computing device, wherein the memory contains one or more digital images, the processor operates under control of the graphical application to produce a set of modified digital images with respect to a digital image. The set of modified digital images are typically produced for display on any host device, to thereby enrich the user-experience when viewing such digital images on a digital screen of the host device. The method involves retrieving one or more digital images from the memory, and then processing each of the retrieved digital images. The processing of each retrieved digital image produces a respective set of modified digital images each with a central portion and a frame portion, such that the central portion produced from content of the processed retrieved digital image, and the frame portion is produced with a frame style and frame attributes that are related to the content of the processed retrieved digital image.

In an embodiment, the graphical application is loaded onto the computing device, for example from a removable memory or another host device, so that retrieving the digital images from the memory is contingent on loading the graphical application onto the computing device. Alternatively, the graphical application may be stored on the computing device and loaded directly from thereon.

In another embodiment, is provided a remote monitoring device, such as a mobile phone, interfacing wirelessly with the computing device for remote operation of the graphical application running on the computing device. In such case, the method may further involve storing commands which instructions are received from the remote monitoring device with respect to the digital images in the memory. Moreover, with a storage device operatively coupled to the computing device via the host interface, the method may further involve communicating with the storage device for executing the stored commands on the storage device.

The disclosure also contemplates a computing device with an interface to a memory, a graphical application that is executed on the computing device and a processor. The processor is operative, under control of the graphical application, to retrieve one or more digital images from the memory and to process each of the retrieved digital images. The processing of each retrieved digital image produces a respective set of modified digital images each with a central portion and a frame portion. The central portion is typically produced from content of the processed retrieved digital image, and the frame portion is produced with a frame style and frame attributes that are related to the content of the processed retrieved digital image. The set of modified digital images are typically produced for display on any host, including a digital photo frame, a pc, a note pad, a cellular, or other mobile device.

In an embodiment, the computing device includes a user interface, such that the processing of each retrieved digital image involves interactive user selection, via the user interface. In another embodiment, the memory is a removable memory in a storage device. As such, the graphical application may reside in the storage device and be loaded from the storage device for execution on the computing device, or reside in the computing device and executed directly from thereon. Moreover, the graphical application may be loaded from the storage device for restricting communication with a graphical application running on the computing device to a privileged resident-application that is loaded from the storage device.

The storage device of this disclosure is provided for storing digital images for display on a host. The storage device is typically any form of mass storage medium, including a hard disk drive, memory card, USB flash drive (“UFD”) or the like, designed either with or without a controller. In an exemplary implementation, the storage device includes a host interface that is configured to couple with a host, a memory for storing digital images, and a controller. The controller is configured to, when the storage device is operatively coupled to a computing device (e.g. PC or laptop) via the host interface, communicate with a graphical application running on the computing device for obtaining a set of modified digital images with respect to a digital image processed by the graphical application. The storage device controller stores the digital images in the memory for further retrieval thereof via the host interface. Each of the modified digital images in the set have each a central portion and a frame portion, such that the central portion is produced from content of the digital image and the frame portion produced with a frame style and frame attributes that are related to the content of the digital image.

In an embodiment, a remote monitoring device, such as a mobile device, interfaces wirelessly with the computing device for remote operation of the graphical application running on the computing device. With the remote monitoring device interfacing wirelessly with the computing device as such, the processor in the computing device operates, under control of the graphical application to store commands which instructions are received from the remote monitoring device with respect to the digital images in the memory. With a storage device then being operatively coupled to the computing device via the host interface, the processor, under control of the graphical application communicates with the storage device for executing the stored commands on the storage device.

Communication between the graphical application of this disclosure and the storage device may be achieved by the graphical application 116, when running on the computing device, employing any set of operating system commands (e.g. read and write commands) that implement an application protocol interface (API) on the storage device. These commands are translated by the host drivers during run time of the graphical application on the computing device in a way that complies with the specific communication protocol defined in the computing device. This allows for operating the storage device and/or graphical application of this disclosure with any host device and further in a way that is transparent to the computing device.

Although the foregoing embodiments have been described in considerable detail with reference to certain preferred versions thereof, other embodiments and versions are possible. Accordingly, the contents of this disclosure are not to be limited in scope by the specific embodiments described herein. Indeed, various modifications, variations, alterations, situations, and equivalents will be apparent to those skilled in the art from the foregoing description and accompanying drawings. Moreover, any activity can be repeated, any activity can be performed by multiple entities, and/or any element can be duplicated. Further, any activity or element can be excluded, the sequence of activities can vary, and/or the interrelationship of elements can vary.

Such, for example, although the embodiments have been described primarily with regard to a read-only partition representing files in a read only memory arrangement and to a removable partition for storing user data, it will be understood that the storage device could be adapted to operate in other data structures and other file system configurations. Further, the functionality of the various features of the described embodiments may be distributed differently. For example, conventional flash memory devices include a flash manager, i.e. a type of internal controller, which manages ingress and egress of data and other internal processes, such as wear leveling, translation of logical memory addresses into physical memory addresses and vice versa. Therefore, the controller 108 of FIG. 1 can either be a separate component that interacts with a flash manager, or the functionalities of a flash manager can be integrated, embedded, or affiliated into the controller 108. According to another example, although the host interface 106 is shown in FIG. 1 as a separate component, it can be an integral part of the controller 108. In yet another example, the storage device of FIG. 1 may be designed as a hard disk drive or the like that is absent a flash manager or any sort of controller and that is directly operated by a host to which it is connected to for performing host commands (e.g. read and write commands) on the storage device. As can be, the spirit and scope of the appended claims should not be limited to the description of the preferred embodiments and versions contained herein.

It will be apparent to one of ordinary skilled in the art that the embodiments as described above may be implemented in many different forms of software, firmware, and hardware components, such as application specific integrated circuits (ASICs), in the implementations illustrated in the figures. The actual software code or specialized control hardware used to implement aspects consistent with the foregoing detailed description is not limiting of the foregoing detailed description. Thus, the operation and behavior of the embodiments were described without specific reference to the specific software code, it being understood that a person of ordinary skill in the art would be able to design software and control hardware to implement the embodiments of the description herein.

It is intended that the foregoing detailed description be understood as an illustration of selected forms that the embodiments can take and does not intend to limit the claims that follow. Also, some of the following claims may state that a component is operative to perform a certain function or configured for a certain task. It should be noted that these are not restrictive limitations. It should also be noted that the acts recited in the claims can be performed in any order—not necessarily in the order in which they are recited. Additionally, any aspect of any of the preferred embodiments described herein can be used alone or in combination with one another.

What is claimed is:

1. A method for graphical manipulation of digital images, the method comprising:
in a computing device with a processor, a memory and a graphical application that is executable on the computing device, wherein the memory contains one or more digital images, performing by the processor, under control of the graphical application:
retrieving one or more digital images from the memory; and
processing each of the retrieved digital images, wherein the processing of each retrieved digital image produces a respective set of modified digital images each with a central portion and a frame portion, the central portion produced from content of the processed retrieved digital image, and the frame portion produced with a frame style and frame attributes that are related to the content of the processed retrieved digital image.

2. The method of claim 1, wherein the set of modified digital images are produced for display on any host.

3. The method of claim 2, wherein the host is one of a digital photo frame, a pc, a note pad, a cellular, or other mobile device.

4. The method of claim 1, wherein the retrieving of the one or more digital images from the memory is contingent on loading the graphical application onto the computing device.

5. The method of claim 1, wherein the computing device has a user interface, and wherein the processing of each retrieved digital image involves interactive user selection, via the user interface.

6. The method of claim 1, wherein the processing of each retrieved digital image involves creating the central portion and the frame portion with respect to a modified digital image.

7. The method of claim 1, wherein the processing of each retrieved digital image involves integrating the frame portion with the central portion to create a modified digital image.

8. The method of claim 1, wherein a remote monitoring device interfacing wirelessly with the computing device for remote operation of the graphical application running on the computing device.

9. The method of claim 8, wherein the remote monitoring device is a mobile phone.

10. The method of claim 8, wherein with the remote monitoring device interfacing wirelessly with the computing device, further performing by the processor, under control of the graphical application:
storing commands which instructions received from the remote monitoring device with respect to the digital images in the memory.

11. The method of claim 10, wherein with a storage device operatively coupled to the computing device via the host interface, further performing by the processor, under control of the graphical application:
communicating with the storage device for executing the stored commands on the storage device.

12. A computing device comprising:
an interface to a memory containing digital images;
a graphical application that is executed on the computing device; and
a processor operative, under control of the graphical application, to:
retrieve one or more digital images from the memory; and
process each of the retrieved digital images, wherein the process of each retrieved digital image produces a respective set of modified digital images each with a central portion and a frame portion, the central portion produced from content of the processed retrieved digital image, and the frame portion produced with a frame style and frame attributes that are related to the content of the processed retrieved digital image.

13. The computing device of claim 12, wherein the graphical application is stored on the computing device and loaded from the computing device.

14. The computing device of claim 12, wherein the processor is configured to communicate with a host for retrieving the one or more digital images from the memory.

15. The computing device of claim 12, wherein the processor is configured to communicate with a removable memory in a storage device for retrieving the one or more digital images from the memory.

16. The computing device of claim 12, wherein the host has a user interface, and wherein the processor processes each retrieved digital image based on interactive user selection coming in to the host via the user interface.

17. The computing device of claim 12, wherein the processor processes each retrieved digital image by integrating the frame portion with the central portion to create a modified digital image.

18. The computing device of claim 12, wherein the processor is configured to, under control of the graphical application, interface wirelessly with a remote monitoring device for allowing remote operation of the graphical application running on the computing device, via the remote monitoring device.

19. The computing device of claim 18, wherein the processor is further configured to store commands which instructions are received from the remote monitoring device with respect to the digital images in the memory.
